(19) United States
(12) Patent Application Publication
(10) Pub. No.: US 2025/0015898 A1
(43) Pub. Date: Jan. 9, 2025

(54) OPTICAL RECEIVER, MASTER STATION DEVICE, OPTICAL COMMUNICATION SYSTEM

(71) Applicant: MITSUBISHI ELECTRIC CORPORATION, Tokyo (JP)

(72) Inventor: Takanori KAWANAKA, Tokyo (JP)

(73) Assignee: MITSUBISHI ELECTRIC CORPORATION, Tokyo (JP)

(21) Appl. No.: 18/894,096

(22) Filed: Sep. 24, 2024

Related U.S. Application Data
(63) Continuation of application No. PCT/JP2022/020159, filed on May 13, 2022.

(51) Int. Cl. H04B 10/69

(52) U.S. Cl. CPC H04B 10/6933; H04B 10/6931; H04B 10/695

(57) ABSTRACT

An optical receiver includes an APD, a preamplifier, a limiting amplifier, and an upper-level system. The preamplifier includes a core amplifier circuit that amplifies a current signal, an AGC that changes a conversion gain of the core amplifier circuit by adjusting a first adjustment value, a single phase differential conversion circuit that converts a single-phase signal from the core amplifier circuit into a differential signal, an ATC that changes a threshold for use in the single phase differential conversion circuit by adjusting a second adjustment value, and a processing unit that associates the first adjustment value obtained by adjustment by the AGC based on an output of the core amplifier circuit and the second adjustment value obtained by adjustment by the ATC based on the output of the core amplifier circuit with identification information of one of the slave station devices to store them in a storage unit.

### CROSS-REFERENCE TO RELATED APPLICATION

This application is a continuation application of International Application PCT/JP2022/020159, filed on May 13, 2022, and designating the U.S., the entire contents of which are incorporated herein by reference.

### BACKGROUND OF THE INVENTION

### 1. Field of the Invention

The present disclosure relates to an optical receiver and a master station device each for use in an optical communication system, and to an optical communication system.

### 2. Description of the Related Art

In recent years, an access optical communication system called passive optical network (PON) system has been widely used, which allows multiple users to share a single optical fiber. A PON system includes a single optical line terminal (OLT), serving as a master station device, and multiple optical network units (ONUs), each of which is a subscriber terminal device and also called slave station device. The OLT and the ONUs are connected to each other via an optical star coupler, which is a passive element requiring no power supply and serves as an optical splitter for splitting an optical signal.

In upstream communication from the ONUs to the OLT, a PON system uses a time division multiplexing scheme, in which the OLT grants permission with respect to the transmission time and the amount of transmission data, to each of the ONUs. The ONU performs upstream communication at timing permitted by the OLT in the amount of transmission data permitted by the OLT.

The distance between the OLT and each of the ONUs depends on the installation locations of the ONU, resulting in different levels of intensity of upstream optical signals received by the OLT. This causes the OLT to receive intermittently upstream signals having various levels of intensity from multiple ONUs. The range of intensity of an optical signal to be received by the OLT is specified in standards and the like, and is accordingly limited to some extent. That range is, for example, from a weak signal having a power level of about −30 dBm or the like to a strong signal having a power level of about −10 dBm or the like. Thus, an OLT is required to receive optical signals different in intensity by 100 times or more.

When a received optical signal has low intensity, the OLT needs to amplify the signal with a high conversion gain to perform processing such as clock and data recovery. A preamplifier is thus widely used that has a high conversion gain and is capable of converting a current signal from a light-receiving device into a voltage signal. However, when an amplifier receives an optical signal having high intensity with a same conversion gain as the conversion gain to be used for an optical signal having low intensity, the optical signal having high intensity will undergo distortion in the waveform in the amplifier. A method is thus widely used in which the conversion gain of the amplifier is adjusted after the optical signal is received. Note that the preamplifier includes a single phase differential conversion circuit to generate a differential signal as the input to the downstream amplifier, and the threshold for use in the single phase differential conversion circuit also needs adjustment when the conversion gain has been adjusted. The method in which the conversion gain and the threshold are adjusted after the optical signal is received fails to allow the preamplifier to output a normal waveform during the settling time from the start of reception of the optical signal until completion of the adjustment. Thus, providing as short a settling time as possible is preferable.

To reduce the settling time, Japanese Patent No. 5811955 suggests a method in which the time constant of the automatic gain adjustment circuit for adjusting the conversion gain and the time constant of the automatic threshold control circuit for adjusting the threshold are each switched from one to another according to a signal detection result. An automatic gain adjustment circuit is hereinafter referred to as automatic gain control (AGC) circuit, and an automatic threshold control circuit is hereinafter referred to as automatic threshold control (ATC) circuit. This method is performed such that the time constants of the AGC circuit and of the ATC circuit are decreased during the adjustment period, and are increased after the adjustments are completed. This can reduce the settling time.

However, the foregoing conventional technology indeed allows reduction of the settling time, but the settling time still remains, and a further reduction of the settling time is demanded.

### SUMMARY OF THE INVENTION

In order to solve the above-described problems and achieve the object, an optical receiver according to the disclosure to be installed in a master station device that receives an optical signal in a time division multiplexing scheme from a plurality of slave station devices, the master station device being connected to the slave station devices via an optical transmission channel, the optical receiver includes: a photoelectric conversion element to convert the optical signal into a current signal; a preamplifier to amplify the current signal output from the photoelectric conversion element and to convert the amplified current signal into a voltage signal; a limiting amplifier to further amplify the voltage signal output from the preamplifier and to limit an amplified amplitude of the voltage signal within a predetermined range; and an upper-level system to output a reset signal to the preamplifier in accordance with timing of reception of the optical signal, wherein the preamplifier includes a core amplifier circuit to amplify the current signal, an automatic gain control circuit to change a conversion gain of the core amplifier circuit by adjusting a first adjustment value, a single phase differential conversion circuit to convert a single-phase signal output from the core amplifier circuit into a differential signal, an automatic threshold control circuit to change a threshold for use in the single phase differential conversion circuit by adjusting a second adjustment value, and a processing unit to associate the first adjustment value obtained by adjustment performed by the automatic gain control circuit on a basis of an output of the core amplifier circuit and the second adjustment value obtained by adjustment performed by the automatic threshold control circuit on a basis of the output of the core amplifier circuit with identification information of a corresponding one of the slave station devices received from the upper-level system, and to store the first adjustment value, the second adjustment value, and the identification information in association with one another in a storage unit.

### BRIEF DESCRIPTION OF THE DRAWINGS

FIG. 1 is a diagram illustrating a configuration of an optical communication system according to a first embodiment;

FIG. 2 is a diagram illustrating a configuration of the optical receiver illustrated in FIG. 1;

FIG. 3 is a diagram illustrating observation points in the preamplifier illustrated in FIG. 2;

FIG. 4 is a diagram illustrating a simplified example of waveforms over time at the observation points illustrated in FIG. 3;

FIG. 5 is an illustrative diagram with respect to processing of registration of a first adjustment value and a second adjustment value performed by the optical receiver illustrated in FIG. 2;

FIG. 6 is a diagram illustrating a configuration of an optical receiver according to a second embodiment; and

FIG. 7 is a diagram illustrating a configuration of an optical receiver according to a third embodiment.

### DETAILED DESCRIPTION OF THE PREFERRED EMBODIMENTS

An optical receiver, a master station device, and an optical communication system according to embodiments of the present disclosure will be described in detail below with reference to the drawings.

### First Embodiment

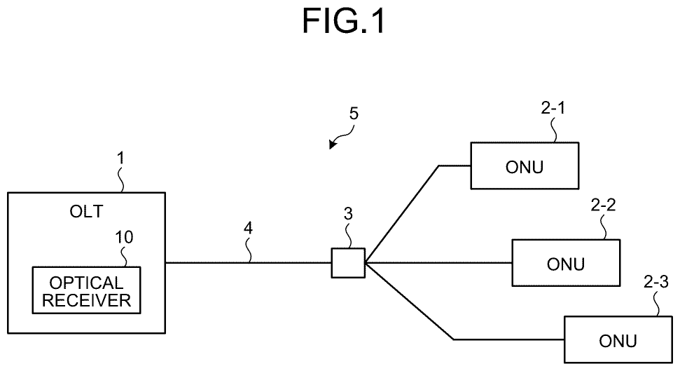

FIG. 1 is a diagram illustrating a configuration of an optical communication system 5 according to a first embodiment. The optical communication system 5 is a PON system including an OLT 1 and a plurality of ONUs 2-1 to 2-3. The OLT 1 is also called master station device, and is connected to the plurality of ONUs 2-1 to 2-3 using an optical splitter 3 and an optical fiber 4, where the optical splitter 3 branches the optical transmission channel. Note that when no distinction is needed among the plurality of ONUs 2-1 to 2-3, the ONUs 2-1 to 2-3 are each referred to simply as ONU 2. The ONU 2 is also called slave station device. Although FIG. 1 illustrates an example in which the single OLT 1 is connected to the three ONUs 2, the number of the ONUs 2 to be connected to the single OLT 1 is not limited to three. The number of the ONUs 2 connected to the single OLT 1 may be two or four or more.

In upstream communication from the ONUs 2 to the OLT 1, the optical communication system 5 uses a time division multiplexing scheme, in which the OLT 1 grants permission with respect to the transmission time and the amount of transmission data, to each of the plurality of ONUs 2. As such, the OLT 1 knows in advance which ONU 2 among the ONUs 2-1 to 2-3 is the ONU 2 that is the source of the optical signal received. The OLT 1 includes an optical receiver 10 for receiving the optical signal.

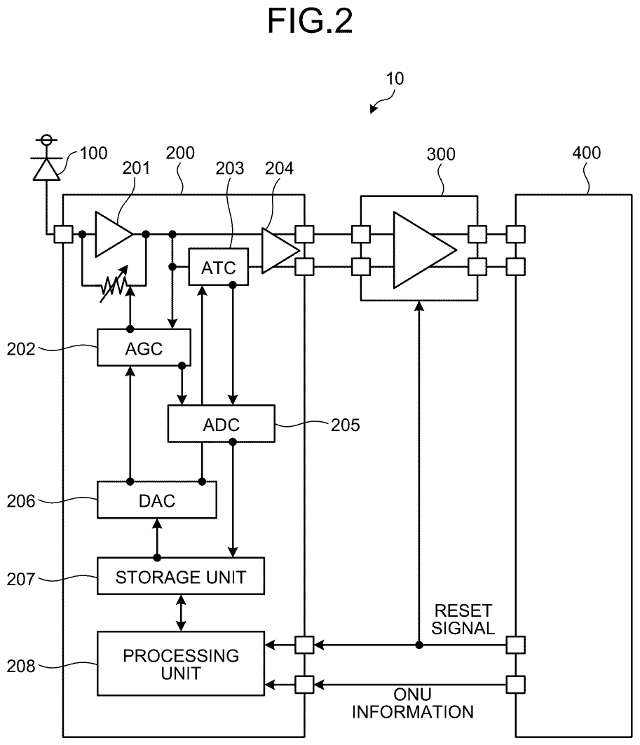

FIG. 2 is a diagram illustrating a configuration of the optical receiver 10 illustrated in FIG. 1. The optical receiver 10 includes an avalanche photodiode (APD) 100, which is a photoelectric conversion element for converting an optical signal into a current signal; a preamplifier 200, which amplifies the current signal output from the APD 100 and converts the amplified current signal into a voltage signal; a limiting amplifier 300, which further amplifies the voltage signal output from the preamplifier 200 and limits an amplified amplitude of the voltage signal within a predetermined range; and an upper-level system 400, which has a clock and data recovery function to extract and reproduce a clock and data from the signal output from the limiting amplifier 300. The upper-level system 400 also performs operations such as providing a reset signal to each of the preamplifier 200 and the limiting amplifier 300, supplying ONU information to the preamplifier 200, and managing the time of arrival of a signal from each of the plurality of ONUs 2 and identification information of the ONUs 2. The ONU information include, for example, identification information of the ONU 2 that is the source of an optical signal to be received next.

The APD 100 converts a received optical signal into a current signal, and outputs the current signal to the preamplifier 200. The preamplifier 200 amplifies the current signal output by the APD 100, converts the amplified current signal into a voltage signal, and outputs the voltage signal to the limiting amplifier 300. The limiting amplifier 300 further amplifies the voltage signal output by the preamplifier 200, limits an amplified amplitude of the voltage signal within a predetermined range, and outputs the voltage signal having the limited amplitude to the upper-level system 400. The upper-level system 400 extracts and reproduces a clock and data from the signal output by the limiting amplifier 300. In addition, the preamplifier 200 controls operation of the preamplifier 200 on the basis of a reset signal output by the upper-level system 400 and on the basis of ONU information including identification information of the ONUs 2, details of which are described later.

The preamplifier 200 includes a core amplifier circuit 201; an AGC 202, which is an automatic gain control circuit; an ATC 203, which is an automatic threshold control circuit; a single phase differential conversion circuit 204; an analog-to-digital converter (ADC) 205; a digital-to-analog converter (DAC) 206; a storage unit 207; and a processing unit 208.

The core amplifier circuit 201 amplifies the current signal from the APD 100. The conversion gain of the core amplifier circuit 201 is adjusted by the AGC 202. The output of the core amplifier circuit 201 is connected to each of the AGC 202, the ATC 203, and the single phase differential conversion circuit 204.

The AGC 202 has functionality to adjust the conversion gain of the core amplifier circuit 201. The AGC 202 is capable of changing the conversion gain of the core amplifier circuit 201 by adjusting the value of a first adjustment value to be output to the core amplifier circuit 201. The AGC 202 has a function to adjust the first adjustment value and to thereby adjust the conversion gain so as to cause the output of the core amplifier circuit 201 to be set at a predetermined level, on the basis of the output of the core amplifier circuit 201. The AGC 202 also has a function to change the conversion gain by outputting the first adjustment value received from the DAC 206 to the core amplifier circuit 201 upon reception of the first adjustment value from the DAC 206. The first adjustment value is a voltage value, and is provided to a feedback resistor unit (not illustrated) of the core amplifier circuit 201. The feedback resistor unit is typically a parallel circuit of a resistor and a metal-oxide-semiconductor field-effect transistor (MOSFET). The first adjustment value acts as a gate voltage of the MOSFET included in the feedback resistor unit of the core amplifier circuit 201. Adjustment of the value of the first adjustment value causes the gate voltage of the MOSFET to be changed, and a change in the resistance value of the feedback resistor unit then causes the signal amplification gain of the core amplifier circuit 201 to be changed. A higher resistance value of the feedback resistor unit provides a higher gain, and a lower resistance value thereof provides a lower gain.

The ATC 203 has a function to adjust the threshold for use in the single phase differential conversion circuit 204. The ATC 203 is capable of changing the threshold to be input to the single phase differential conversion circuit 204 by adjusting a second adjustment value to be output to the single phase differential conversion circuit 204. The ATC 203 has a function to adjust the second adjustment value on the basis of the output of the core amplifier circuit 201 to thereby adjust the threshold for use in the single phase differential conversion circuit 204. The ATC 203 also has a function to adjust the threshold by outputting the second adjustment value received from the DAC 206 to the single phase differential conversion circuit 204 upon reception of the second adjustment value from the DAC 206. The second adjustment value is a voltage value, and is used as an input voltage of one of two inputs of a differential amplifier circuit constituting the single phase differential conversion circuit 204.

The single phase differential conversion circuit 204 receives, as the input, the output of the core amplifier circuit 201 and the output of the ATC 203, i.e., the threshold, and converts a single-phase signal into a differential signal. For example, the output of the core amplifier circuit 201 can be used as the in-phase input of the single phase differential conversion circuit 204, and the output of the ATC 203, i.e., the threshold, can be used as the antiphase input of the single phase differential conversion circuit 204. The differential amplifier circuit constituting the single phase differential conversion circuit 204 is a current model logic (CML) circuit based on a general MOSFET, an emitter-coupled logic (ECL) based on a bipolar transistor, or the like. When the single phase differential conversion circuit 204 is configured by using a CML circuit, the second adjustment value acts as a gate voltage of the MOSFET included in the CML circuit. When the single phase differential conversion circuit 204 is configured by using an ECL, the second adjustment value acts as a base voltage of the bipolar transistor included in the ECL. Now, let DC1 denote the in-phase input signal center of the single phase differential conversion circuit 204, and let DC2 denote the antiphase input signal center thereof. In this case, the value of a direct current (DC) offset “DC1-DC2” is ideally 0 mV for achieving a high amplification factor and an output differential signal without distortion. An example of signal without distortion is a sine wave having a duty cycle of 50%. In this respect, when the DC offset “DC1-DC2” has a value different from 0 mV, an amplification factor of the single phase differential conversion circuit 204 is lowered, thereby causing the output differential signal to have a distorted signal waveform. That is, even when the output voltage of the core amplifier circuit 201 has a constant amplitude, a DC offset “DC1-DC2” having a value deviated more from 0 mV results in a smaller output voltage amplitude of the single phase differential conversion circuit 204, thereby also causing the duty cycle to deviate more from 50%. The optical receiver 10 thus performs control to make the value of DC2 approach DC1 so as to make the value of “DC1-DC2” approach 0 mV. The value of DC2 is the output of the ATC 203, i.e., the second adjustment value, and is the threshold for use in the single phase differential conversion circuit 204. Thus, the optical receiver 10 performs control to cause the second adjustment value to approach the value of DC1, i.e., the output signal center of the core amplifier circuit 201. The differential signal output by the single phase differential conversion circuit 204 is input to the limiting amplifier 300.

The ADC 205 converts an analog value into a digital value. The ADC 205 is capable of converting the first adjustment value and the second adjustment value output respectively by the AGC 202 and the ATC 203, which are analog values, into digital values, and outputting the digital values obtained by conversion to the storage unit 207.

The DAC 206 converts a digital value into an analog value. The DAC 206 is capable of converting the first adjustment value stored in the storage unit 207 from a digital value to an analog value, and outputting the first adjustment value that is now an analog value obtained by the conversion, to the AGC 202. The DAC 206 is also capable of converting the second adjustment value stored in the storage unit 207 from a digital value to an analog value, and outputting the second adjustment value that is now an analog value obtained by the conversion, to the ATC 203.

The storage unit 207 has a function to store the first adjustment value and the second adjustment value output by the ADC 205, which are each a digital value. The storage unit 207 is capable of outputting the first adjustment value and the second adjustment value stored therein to the DAC 206, according to an instruction from the processing unit 208.

The processing unit 208 is a simple circuit that controls operation of the preamplifier 200. The processing unit 208 is capable of receiving a reset signal and ONU information from the upper-level system 400, and controlling the operation of the preamplifier 200 on the basis of the information received from the upper-level system 400. The control performed by the processing unit 208 will be described in detail later.

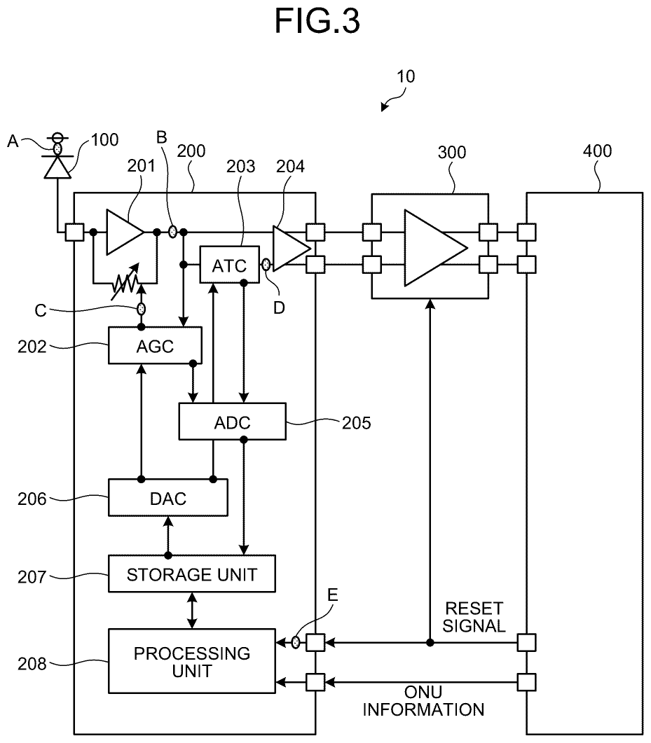

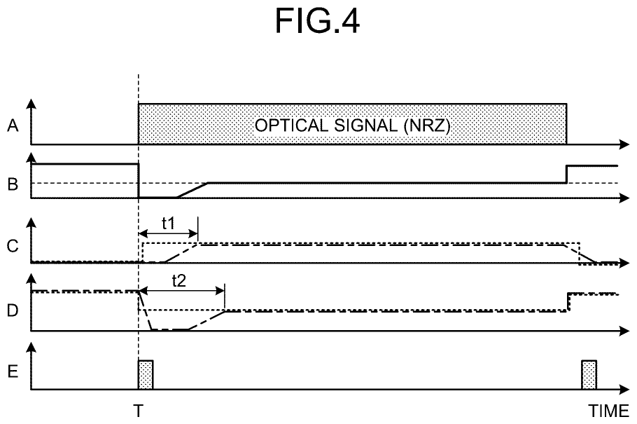

FIG. 3 is a diagram illustrating observation points in the preamplifier 200 illustrated in FIG. 2. FIG. 4 is a diagram illustrating a simplified example of waveforms over time at the observation points illustrated in FIG. 3. The observation points illustrated in FIG. 3 will first be described. Observation point A is an input point to the APD 100, at which observation is made of the optical signal to be input to the APD 100. Observation point B is an output point of the core amplifier circuit 201, at which observation is made of the signal obtained by amplification performed by the core amplifier circuit 201. Observation point C is an output point from the AGC 202 to the core amplifier circuit 201, at which the first adjustment value is observed. Observation point D is an output point of the ATC 203, at which the second adjustment value is observed. Observation point E is an input point from the upper-level system 400 to the processing unit 208, at which the reset signal is observed.

As observed at observation point A, an optical signal from one of the ONUs 2 is received at time T. At this time, because timing of arrival of the optical signal from the ONU 2 is known, a reset signal is provided so as to be observed at observation point E in conjunction with the arrival of the optical signal at time T. After receiving the optical signal, the core amplifier circuit 201 performs inverting amplification to cause the output of the core amplifier circuit 201 to have a largely reduced direct current (DC) level so as to be observed at observation point B. The broken line illustrated in the graph of observation point B represents the output level of the core amplifier circuit 201 at an appropriate conversion gain.

The dashed-and-dotted lines respectively represent the waveforms over time at observation point C and at observation point D that would be obtained when the AGC 202 and the ATC 203 respectively adjust the conversion gain and the threshold by adjusting the values of the first adjustment value and of the second adjustment value on the basis of the output of the core amplifier circuit 201 as conventionally performed.

First, after receiving the optical signal, the AGC 202 determines whether the output of the core amplifier circuit 201 is at a higher or lower level than an appropriate level. When the AGC 202 determines that the conversion gain is higher than an appropriate value thereby causing the output of the core amplifier circuit 201 to be at a lower level than an appropriate level as illustrated in FIG. 4, the AGC 202 adjusts the first adjustment value to reduce the conversion gain. Note that this example assumes that a higher value of the first adjustment value observed at observation point C provides a lower conversion gain, but on the contrary, a lower value of the first adjustment value may provide a lower conversion gain. The time required for the AGC 202 to perform the adjustment is herein designated by t1. The time t1 is about several tens of nanoseconds in a fast case.

Next, the ATC 203 is often designed to follow the output of the core amplifier circuit 201. In this case, the value at observation point D behaves similarly to the value at observation point B. There may be cases, however, in which this will not apply, depending on the design of the circuit. The second adjustment value observed at observation point D is preferably a value adapted to the DC level of the output of the core amplifier circuit 201 observed at observation point B. The second adjustment value may therefore be generated by removing high-frequency components from the waveform at observation point B using a low-pass filter or the like. In this case, the waveform at observation point D varies moderately over time. When the ATC 203 is operated to follow the output of the core amplifier circuit 201, the adjustment operation of the ATC 203 will be completed after the adjustment operation of the AGC 202 is completed. Denoting by t2 the time required for the ATC 203 to perform adjustment, t2 has a value greater than t1.

A method of adjustment of the first adjustment value and the second adjustment value when the optical receiver 10 of the present embodiment receives an optical signal will next be described. The optical receiver 10 has stored a preregistered first adjustment value and second adjustment value in the storage unit 207 on a per-ONU 2 basis. In the optical receiver 10, the timing of arrival of an optical signal from each of the ONUs 2 is known. The optical receiver 10 can accordingly reduce the time required for the adjustments by changing the conversion gain and the threshold in conjunction with the arrival of the optical signal using the preregistered first adjustment value and second adjustment value. The waveforms over time at observation point C and at observation point D of FIG. 4 in this case are represented by the broken lines. The times t1 and t2 required for the adjustments can theoretically be reduced to zero. A concrete operation is as follows. The upper-level system 400 of the optical receiver 10 outputs a reset signal to the preamplifier 200 in accordance with the known timing of signal reception, and the processing unit 208 of the preamplifier 200 provides the first adjustment value and the second adjustment value stored in the storage unit 207 respectively to the AGC 202 and to the ATC 203 at the timing in accordance with the reset signal. The AGC 202 changes the conversion gain by using the first adjustment value provided, and the ATC 203 changes the threshold by using the second adjustment value provided.

Note that performing adjustment of the first adjustment value and the second adjustment value instantaneously in conjunction with the arrival of the optical signal as described above requires preregistration of the first adjustment value and the second adjustment value to be used. Registration operation of the first adjustment value and the second adjustment value will next be described.

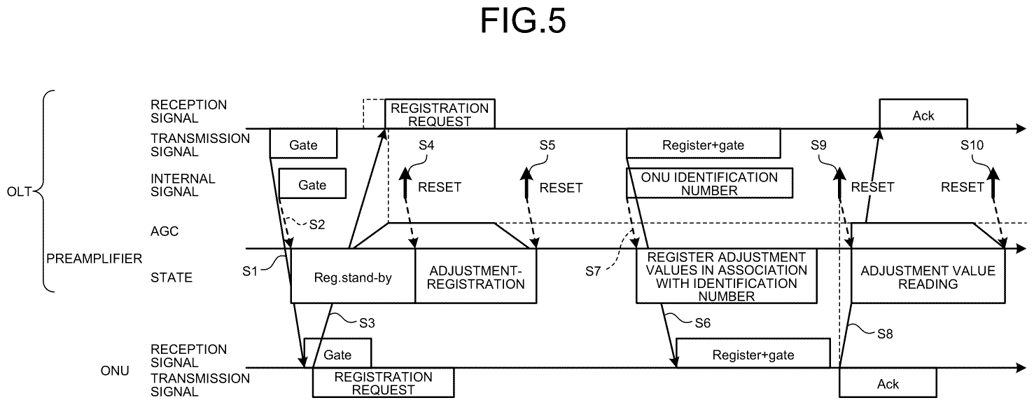

FIG. 5 is an illustrative diagram with respect to processing of registration of the first adjustment value and the second adjustment value performed by the optical receiver 10 illustrated in FIG. 2. FIG. 5 illustrates reception signals of the OLT 1, transmission signals of the OLT 1, internal signals of the OLT 1, outputs of the AGC 202 in the preamplifier 200 of the OLT 1, the state of the preamplifier 200, reception signals of the ONU 2, and transmission signals of the ONU 2. The internal signals of the OLT 1 refer to signals transmitted and received inside the OLT 1, for example, between the upper-level system 400 and the preamplifier 200. The ONU 2 is one of the ONUs 2-1 to 2-3 illustrated in FIG. 1.

The processing of FIG. 5 begins at the time when the ONU 2 is first connected to a network. To check whether there is a newly connected ONU 2 in the network, the OLT 1 transmits a Gate signal (step S1). In synchronization with the Gate signal transmitted to the ONU 2, a Gate signal is provided to the preamplifier 200 as an internal signal (step S2). In this respect, the electrical path to provide the Gate signal to the preamplifier 200 may be the signal line for providing the reset signal illustrated in FIG. 2, the signal line for providing the ONU information illustrated in FIG. 2, or another signal line different from these signal lines that is separately installed.

Upon reception of the Gate signal, the preamplifier 200 transitions to “Reg. stand-by” state, in which processing of registration of the first adjustment value and the second adjustment value is performed. Note that the following description may refer to each of the first adjustment value and the second adjustment value simply as adjustment value. Upon reception of the Gate signal, the ONU 2 transmits, to the OLT 1, a registration request including necessary information for registration for the ONU 2 itself in the network (step S3).

Upon reception of the registration request from the ONU 2, the OLT 1 performs processing of adjustment of the adjustment values on the basis of the output of the core amplifier circuit 201 in a conventional manner because adjustment values suitable for this ONU 2 are unknown at this stage of operation. After completion of adjustment of the adjustment values, the OLT 1 provides, to the preamplifier 200, a reset signal indicating that a signal has been received from the ONU 2, as an internal signal (step S4). The preamplifier 200 converts the adjustment values at the time of reception of this reset signal into digital signals, and registers the adjustment values in the storage unit 207. At this stage of operation, the registered adjustment values are not associated with the identification information of the ONU 2. Upon reception of another reset signal as an internal signal (step S5), the preamplifier 200 terminates an adjustment value registering state.

After reception of the registration request, the OLT 1 determines the transmission timing and the amount of transmission data of the ONU 2, and then transmits a “Register+gate” signal, which is a signal containing these assignment information and is a registration confirmation message for the ONU 2 (step S6). In this operation, the OLT 1 provides a data sequence containing the identification information of the ONU 2 to the preamplifier 200 as an internal signal (step S7). Upon reception of this identification information, the preamplifier 200 associates the adjustment values already stored in the storage unit 207 with the identification information received, and registers these adjustment values and the identification information in association with each other. For example, the preamplifier 200 can associate the adjustment values with the identification information by associating a register address with the identification information of the ONU 2.

Upon reception of the “Register+gate” signal, the ONU 2 transmits an Ack signal for acknowledgment of the reception (step S8). Because the timing of arrival of the signal from the ONU 2 is known at this stage of operation, the OLT 1 provides a reset signal and the identification information for identifying the ONU 2 that is the source of the signal received, as internal signals, in accordance with timing of reception of the Ack signal (step S9).

Because the adjustment values have already been registered, the preamplifier 200 reads, in accordance with the reset signal, the adjustment values which are associated with the provided identification information and stored in the storage unit 207, and provides the adjustment values respectively to the AGC 202 and to the ATC 203. Adjustment of the adjustment values is thus completed instantaneously. Adjustment of the adjustment values results in adjustment of the conversion gain and of the threshold. Upon termination of the signal from the ONU 2, the OLT 1 provides a reset signal to the preamplifier 200 as an internal signal (step S10). The preamplifier 200 terminates an adjustment value reading state at timing in accordance with this reset signal.

As described above, the optical receiver 10 according to the first embodiment is the optical receiver 10 to be installed in the OLT 1, which is a master station device that is connected to the ONUs 2 via an optical transmission channel to receive an optical signal in a time division multiplexing scheme from the plurality of ONUs 2, which are a plurality of slave station devices. The optical receiver 10 includes the APD 100, which is a photoelectric conversion element that converts an optical signal into a current signal; the preamplifier 200, which amplifies the current signal output from the APD 100 and converts the amplified current signal into a voltage signal; the limiting amplifier 300, which further amplifies the voltage signal output from the preamplifier 200, and limits an amplified amplitude of the voltage signal within a predetermined range; and the upper-level system 400, which outputs a reset signal to the preamplifier 200 in accordance with timing of reception of an optical signal. The preamplifier 200 includes the core amplifier circuit 201; the AGC 202, which is an automatic gain control circuit that changes the conversion gain of the core amplifier circuit by adjusting the first adjustment value; the single phase differential conversion circuit 204, which converts a single-phase signal output by the core amplifier circuit 201 into a differential signal; the ATC 203, which is an automatic threshold control circuit that changes the threshold for use in the single phase differential conversion circuit 204 by adjusting the second adjustment value; and the processing unit 208, which associates the first adjustment value obtained by adjustment performed by the AGC 202 on the basis of the output of the core amplifier circuit 201 and the second adjustment value obtained by adjustment performed by the ATC 203 on the basis of the output of the core amplifier circuit 201 with the identification information of each corresponding one of the ONUs 2 received from the upper-level system 400, and stores the first adjustment value, the second adjustment value, and the identification information in association with one another, in the storage unit 207. The processing of the processing unit 208 of associating the first adjustment value and the second adjustment value with the identification information and of storing these data is performed, for example, as part of initial registration processing when the corresponding one of the ONUs 2 is first connected to the network.

Such configuration enables the first adjustment value and the second adjustment value that are appropriate at the time of reception of an optical signal from each of the ONUs 2 to be associated with, and be stored together with, the identification information of each corresponding one of the ONUs 2. The time required for the adjustments can thus be reduced by using the adjustment values stored in advance when the conversion gain of the core amplifier circuit 201 and the threshold for use in the single phase differential conversion circuit 204 are adjusted.

The AGC 202 changes the conversion gain of the core amplifier circuit 201 using the first adjustment value stored in the storage unit 207 at timing in accordance with a reset signal, and the ATC 203 changes the threshold using the second adjustment value stored in the storage unit 207 at timing in accordance with the reset signal. In this manner, adjustment of the conversion gain and of the threshold can be completed at timing in accordance with a reset signal provided in accordance with known reception timing, thereby enabling the preamplifier 200 to output a normal waveform from the beginning.

### Second Embodiment

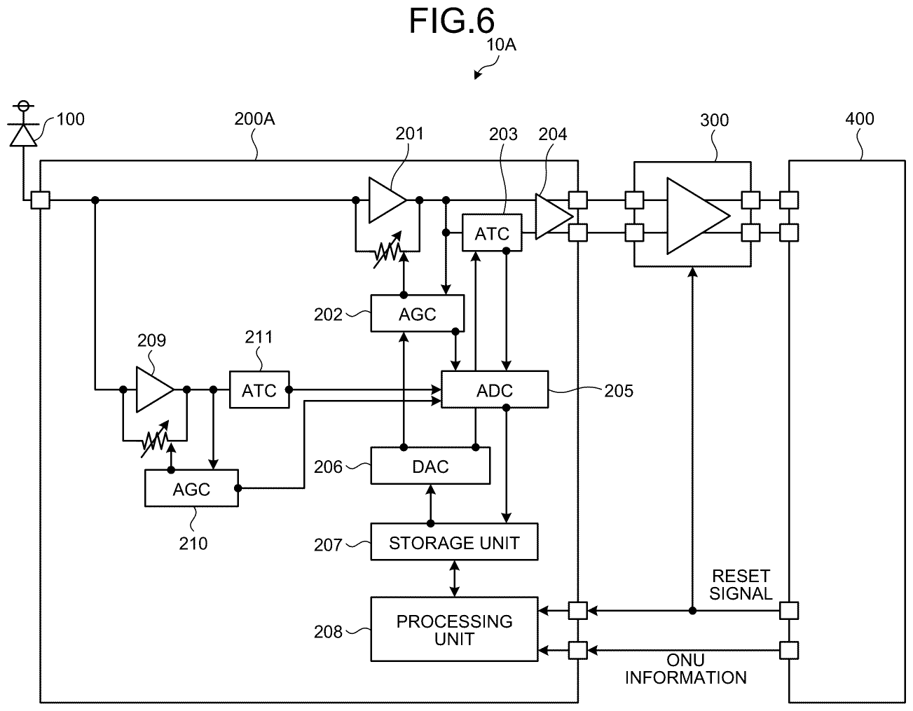

FIG. 6 is a diagram illustrating a configuration of an optical receiver 10A according to a second embodiment. The optical receiver 10A is installed in the OLT 1. The optical receiver 10A includes the APD 100, a preamplifier 200A, the limiting amplifier 300, and the upper-level system 400, and includes the preamplifier 200A in place of the preamplifier 200 of the optical receiver 10. The following description will be primarily presented in the context of differences from the optical receiver 10 according to the first embodiment, and detailed description of portions common to the first embodiment will be omitted.

The preamplifier 200A includes, in addition to the components of the preamplifier 200, an adjustment-purpose core amplifier circuit 209, which amplifies the current signal from the APD 100; an AGC 210, which is an adjustment-purpose automatic gain control circuit that changes the conversion gain of the adjustment-purpose core amplifier circuit 209 by adjusting a third adjustment value on the basis of an output of the adjustment-purpose core amplifier circuit 209; and an ATC 211, which is an adjustment-purpose automatic threshold control circuit that adjusts a fourth adjustment value on the basis of the output of the adjustment-purpose core amplifier circuit 209. The processing unit 208 is capable of causing the ADC 205 to convert the third adjustment value obtained by adjustment performed by the AGC 210 and the fourth adjustment value obtained by adjustment performed by the ATC 211 into digital values, of updating the first adjustment value stored in the storage unit 207 using the third adjustment value obtained by conversion, and of updating the second adjustment value stored in the storage unit 207 using the fourth adjustment value obtained by adjustment performed by the ATC 211. In this operation, the processing unit 208 updates the first adjustment value and the second adjustment value that were in use when the third adjustment value and the fourth adjustment value were adjusted.

This enables the optical receiver 10A to update the first adjustment value and the second adjustment value that have been once registered in the storage unit 207. Thus, even when the appropriate adjustment values have changed due to an environmental change, aging degradation, and/or the like, such changes can be addressed.

### Third Embodiment

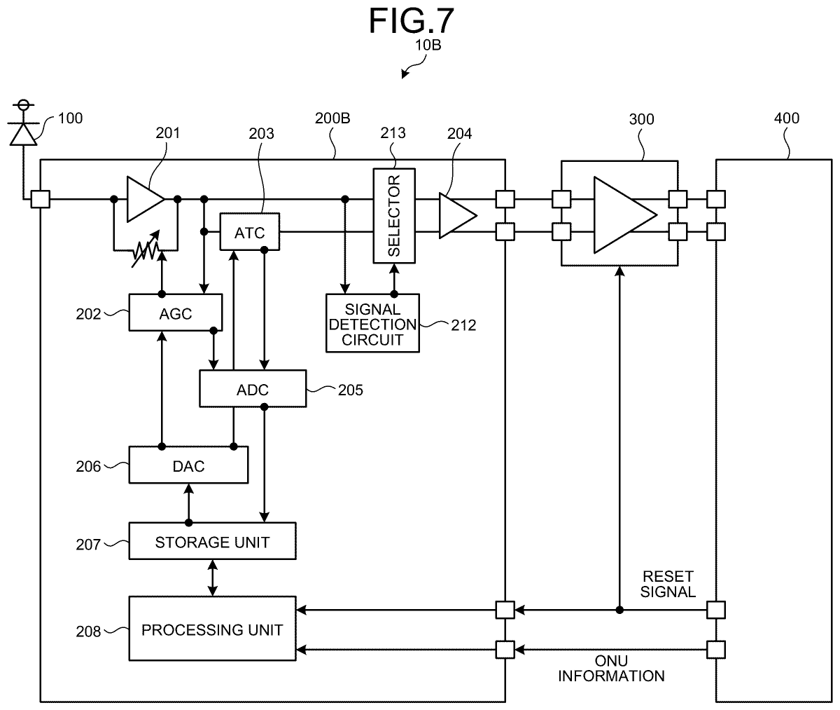

FIG. 7 is a diagram illustrating a configuration of an optical receiver 10B according to a third embodiment. The optical receiver 10B is installed in the OLT 1. The optical receiver 10B includes the APD 100, a preamplifier 200B, the limiting amplifier 300, and the upper-level system 400, and includes the preamplifier 200B in place of the preamplifier 200 of the optical receiver 10. The following description will be primarily presented in the context of differences from the optical receiver 10 according to the first embodiment, and detailed description of portions common to the first embodiment will be omitted.

The preamplifier 200B includes, in addition to the components of the preamplifier 200, a signal detection circuit 212 for detecting the signal included in the output of the core amplifier circuit 201, and a selector 213, which switches the connection to the input terminal of the single phase differential conversion circuit 204 on the basis of a signal detection result of the signal detection circuit 212. The selector 213 is capable of switching states between a first state in which the output of the ATC 203 is connected to the differential input of the single phase differential conversion circuit 204 and a second state in which the output of the ATC 203 is connected to the single-phase input of the single phase differential conversion circuit 204. In the second state, the output of the ATC 203 is connected to one-side input of the single-phase inputs of the single phase differential conversion circuit 204, and the output of the core amplifier circuit 201 is connected to the other one-sided input thereof. The selector 213 selects the first state during a time period after completion of adjustment of the conversion gain of the core amplifier circuit 201 and of the threshold for use in the single phase differential conversion circuit 204 until the signal detection circuit 212 detects a signal, and selects the second state after the signal detection circuit 212 detects the signal. This can prevent occurrence of a DC offset between the differential outputs of the preamplifier 200B in a no-signal section after a reset signal is input. When a DC offset occurs between the differential outputs of the preamplifier 200B, that is, when the value of aforementioned “DC1-DC2” is not 0 mV, a case may occur where the amplification factor of the single phase differential conversion circuit 204 is reduced, and the single phase differential conversion circuit 204 undergoes distortion of the output waveform. Moreover, a DC offset large enough to exceed the input-output range of the single phase differential conversion circuit 204 may result in a situation in which no waveform is output from the single phase differential conversion circuit 204. Elimination of the DC offset enables such situation to be avoided, and enables the OLT 1 to continue stable operation.

The configurations described in the foregoing embodiments are merely examples. These configurations may be combined with another known technology, and configurations of different embodiments may be combined together. Moreover, part of such configurations may be omitted and/or modified without departing from the spirit thereof.

For example, although the foregoing embodiments have been described in the context of an avalanche photodiode as an example of photoelectric conversion element, the photoelectric conversion element may be a photoelectric conversion element other than an avalanche photodiode. For example, the photoelectric conversion element may be a PIN junction-type photodiode.

In addition, although the foregoing embodiments have been described in which the output of the core amplifier circuit 201 is input to the in-phase input of the single phase differential conversion circuit 204, and the output of the ATC 203, i.e., the threshold, is input to the antiphase input of the single phase differential conversion circuit 204, however, the output of the ATC 203, i.e., the threshold, may be input to the in-phase input of the single phase differential conversion circuit 204, and the output of the core amplifier circuit 201 may be input to the antiphase input of the single phase differential conversion circuit 204.

An optical receiver according to the present disclosure provides an advantage in capability of further reducing the settling time, which is the time required from the start of reception of an optical signal until completion of adjustment of the conversion gain and of the threshold.

What is claimed is:

1. An optical receiver to be installed in a master station device that receives an optical signal in a time division multiplexing scheme from a plurality of slave station devices, the master station device being connected to the slave station devices via an optical transmission channel, the optical receiver comprising:
a photoelectric conversion element to convert the optical signal into a current signal;
a preamplifier to amplify the current signal output from the photoelectric conversion element and to convert the amplified current signal into a voltage signal;
a limiting amplifier to further amplify the voltage signal output from the preamplifier and to limit an amplified amplitude of the voltage signal within a predetermined range; and
upper-level circuitry to output a reset signal to the preamplifier in accordance with timing of reception of the optical signal, wherein
the preamplifier includes
core amplifier circuitry to amplify the current signal,
automatic gain control circuitry to change a conversion gain of the core amplifier circuitry by adjusting a first adjustment value,
single phase differential conversion circuitry to convert a single-phase signal output from the core amplifier circuitry into a differential signal,
automatic threshold control circuitry to change a threshold for use in the single phase differential conversion circuitry by adjusting a second adjustment value, and
processing circuitry to associate the first adjustment value obtained by adjustment performed by the automatic gain control circuitry on a basis of an output of the core amplifier circuitry and the second adjustment value obtained by adjustment performed by the automatic threshold control circuitry on a basis of the output of the core amplifier circuitry with identification information of a corresponding one of the slave station devices received from the upper-level circuitry, and to store the first adjustment value, the second adjustment value, and the identification information in association with one another in a memory, wherein
the automatic gain control circuitry changes the conversion gain at timing in accordance with the reset signal, using the first adjustment value stored in the memory, and
the automatic threshold control circuitry changes the threshold at timing in accordance with the reset signal, using the second adjustment value stored in the memory.

2. The optical receiver according to claim 1, wherein the processing unit provides, at the timing in accordance with the reset signal, the first adjustment value and the second adjustment value respectively to the automatic gain control circuitry and to the automatic threshold control circuitry, the first adjustment value and the second adjustment value being stored in the memory in association with the corresponding one of the slave station devices that is a source of an optical signal to be received.

3. An optical receiver to be installed in a master station device that receives an optical signal in a time division multiplexing scheme from a plurality of slave station devices, the master station device being connected to the slave station devices via an optical transmission channel, the optical receiver comprising:
a photoelectric conversion element to convert the optical signal into a current signal;
a preamplifier to amplify the current signal output from the photoelectric conversion element and to convert the amplified current signal into a voltage signal;
a limiting amplifier to further amplify the voltage signal output from the preamplifier and to limit an amplified amplitude of the voltage signal within a predetermined range; and
upper-level circuitry to output a reset signal to the preamplifier in accordance with timing of reception of the optical signal, wherein
the preamplifier includes
core amplifier circuitry to amplify the current signal,
automatic gain control circuitry to change a conversion gain of the core amplifier circuitry by adjusting a first adjustment value,
single phase differential conversion circuitry to convert a single-phase signal output from the core amplifier circuitry into a differential signal,
automatic threshold control circuitry to change a threshold for use in the single phase differential conversion circuitry by adjusting a second adjustment value,
processing circuitry to associate the first adjustment value obtained by adjustment performed by the automatic gain control circuitry on a basis of an output of the core amplifier circuitry and the second adjustment value obtained by adjustment performed by the automatic threshold control circuitry on a basis of the output of the core amplifier circuitry with identification information of a corresponding one of the slave station devices received from the upper-level circuitry, and to store the first adjustment value, the second adjustment value, and the identification information in association with one another in a memory,
adjustment-purpose core amplifier circuitry to amplify the current signal output from the photoelectric conversion element,
adjustment-purpose automatic gain control circuitry to change a conversion gain of the adjustment-purpose core amplifier circuitry by adjusting a third adjustment value on a basis of an output of the adjustment-purpose core amplifier circuitry, and
adjustment-purpose automatic threshold control circuitry to adjust a fourth adjustment value on a basis of the output of the adjustment-purpose core amplifier circuitry,
the preamplifier updates the first adjustment value stored in the memory using the third adjustment value, and
the preamplifier updates the second adjustment value stored in the memory using the fourth adjustment value.

4. An optical receiver to be installed in a master station device that receives an optical signal in a time division multiplexing scheme from a plurality of slave station devices, the master station device being connected to the slave station devices via an optical transmission channel, the optical receiver comprising:
a photoelectric conversion element to convert the optical signal into a current signal;
a preamplifier to amplify the current signal output from the photoelectric conversion element and to convert the amplified current signal into a voltage signal;
a limiting amplifier to further amplify the voltage signal output from the preamplifier and to limit an amplified amplitude of the voltage signal within a predetermined range; and
upper-level circuitry to output a reset signal to the preamplifier in accordance with timing of reception of the optical signal, wherein
the preamplifier includes
core amplifier circuitry to amplify the current signal,
automatic gain control circuitry to change a conversion gain of the core amplifier circuitry by adjusting a first adjustment value,
single phase differential conversion circuitry to convert a single-phase signal output from the core amplifier circuitry into a differential signal,
automatic threshold control circuitry to change a threshold for use in the single phase differential conversion circuitry by adjusting a second adjustment value,
a processing unit to associate the first adjustment value obtained by adjustment performed by the automatic gain control circuitry on a basis of an output of the core amplifier circuitry and the second adjustment value obtained by adjustment performed by the automatic threshold control circuitry on a basis of the output of the core amplifier circuitry with identification information of a corresponding one of the slave station devices received from the upper-level circuitry, and to store the first adjustment value, the second adjustment value, and the identification information in association with one another in a memory,
signal detection circuitry to detect a signal included in the output of the core amplifier circuitry, and
a selector capable of switching states between a first state in which an output of the automatic threshold control circuitry is connected to a differential input of the single phase differential conversion circuitry and a second state in which the output of the automatic threshold control circuitry is connected to a single-phase input of the single phase differential conversion circuitry, the states being switched on a basis of a signal detection result of the signal detection circuitry, and
the selector selects the first state during a time period after the automatic threshold control circuitry changes the threshold using the second adjustment value according to the reset signal until the signal detection circuitry detects a signal, and selects the second state after the signal detection circuitry detects the signal.

5. The optical receiver according to claim 1, wherein the photoelectric conversion element is an avalanche photodiode.

6. A master station device comprising the optical receiver according to claim 1.

7. A master station device comprising the optical receiver according to claim 2.

8. A master station device comprising the optical receiver according to claim 3.

9. A master station device comprising the optical receiver according to claim 4.

10. A master station device comprising the optical receiver according to claim 5.

11. An optical communication system comprising:
a master station device including the optical receiver according to claim 1; and
a plurality of slave station devices connected to the master station device via an optical transmission channel.

12. An optical communication system comprising:
a master station device including the optical receiver according to claim 2; and
a plurality of slave station devices connected to the master station device via an optical transmission channel.

13. An optical communication system comprising:
a master station device including the optical receiver according to claim 3; and
a plurality of slave station devices connected to the master station device via an optical transmission channel.

14. An optical communication system comprising:
a master station device including the optical receiver according to claim 4; and
a plurality of slave station devices connected to the master station device via an optical transmission channel.

15. An optical communication system comprising:
a master station device including the optical receiver according to claim 5; and
a plurality of slave station devices connected to the master station device via an optical transmission channel.
